(19) United States
(12) Patent Application Publication
(10) Pub. No.: US 2008/0207426 A1
(43) Pub. Date: Aug. 28, 2008

(54) Heat Insulating Composite and Methods of Manufacturing Thereof

(75) Inventor: Olivier Ralston Forsman-White, Bovenkarspel (NL)

Correspondence Address: KAPLAN GILMAN GIBSON & DERNIER L.L.P., 900 ROUTE 9 NORTH, WOODBRIDGE, NJ, 07095, US

(73) Assignee: ADVANCED GLASS CERAMICS ESTABLISHMENT, Vaduz (LI)

(21) Appl. No.: 11/916,195

(22) PCT Filed: May 30, 2006
(86) PCT No.: PCT/EP06/05149

§ 371 Date: Jan. 11, 2008

(30) Foreign Application Priority Data
May 31, 2005 (EP) PCT/EP2005/006039

(51) Int. Cl. C03C 14/00

(52) U.S. Cl. 501/32

(57) ABSTRACT

Heat insulating panels are widely used in various domains, for example construction sites or hospitals. These panels require adhesives which may generate heat when the panels are subjected to high temperatures. In the field of high temperature insulation, ceramics are brittle and may not be suitable in some applications. This invention discloses a heat-insulating composite including a plurality of glass, and a binder composition for fusing the glass when the heat-insulting composite is exposed to a temperature higher than 1000C. It was found that as the heat progresses from the outer surface to the inner surface of the composite, plurality of laminated ceramic-like structures are formed, which may assist further in insulating the heat. Interestingly, these laminated ceramic-like structures are found to be rubber-like and therefore not brittle.

### FIELD OF THE INVENTION

The present invention relates to the field of heat insulating materials. Particularly, the present invention relates to heat insulating composites, more particularly those use for insulating high temperatures.

### BACKGROUND OF THE INVENTION

Heat insulating panels are widely used in various domains, for example construction sites or hospitals. Ideally, the panels should be lightweight, strong, fire resistant, and non-toxic. Traditionally, such panels include a lightweight centre core structure comprising polyurethanes and polyethylene foams that is sandwiched between two face sheets. This construction suffers from at least one drawback, namely the laminated structures may crackle. Further, the face sheets are susceptible to scratching if they are adhered to the core structure inadequately. This will expose the core structure, which is often coated with epoxy-based adhesives to bind the face sheets. These epoxy-based adhesives tend to burn easily and produce toxic substances when they burn.

Several attempts have been made to address the above issues, including increasing the degree of halogenation of the adhesives, and using other types of adhesives, for example phenolic adhesives. However, these alternatives are found to have either a weaker adhesion than the epoxy adhesives, or evolve toxic substances upon heating.

In the field of high temperature insulation, Ni alloys remained the dominate material in the hot sections of modern turbine engines. However, the limit of nickel alloys may be reached. Current state-of-the-art turbine blade surface temperatures are near to 1150° C. (2100° F.) while the combinations of stress and temperature corresponds to an average bulk metal temperature approaching 1000° C. (1830° F.). Ceramics have been suggested as a possible alternatives, but they are not selected for many applications because the brittleness of monolithic ceramics makes designers wary. In the search for improvement, material scientists conceived the idea of reinforcing ceramics with continuous strands of high-temperature ceramic fiber. Embedded continuous ceramic fibers reinforce the ceramic matrix by deflecting and bridging fractures. However this only deals with part of the problem. These composites are susceptible to “creep fracturing”. This is a problem with ceramics embedded with ceramic fibers, in which the ceramic fibers are susceptible to hair-line fractures at the interfaces of the embedded fibers with the ceramic. Rather than failing suddenly with a critical fracture, the material permanently strains over a longer period of time until it finally fails. Creep does not happen upon sudden loading but on the accumulation of “creep” strain over a longer period of time, which can cause catastrophic failure of the material.

Therefore there may be a need to develop new composite materials that can provide insulation to high temperatures but at the same time avoiding emission of toxic gases. There may also be a need to develop new materials that may replace ceramics in the field of high-temperature insulation but without at least the brittleness drawback.

### OBJECTS OF THE INVENTION

Therefore, it is an object of this invention to provide a heat-insulating material which substantially ameliorates at some of the deficiencies as set forth in the prior art. As a minimum, it is an object of this invention to provide the public with a useful choice.

### SUMMARY OF THE INVENTION

Accordingly, this invention provides a heat insulating composite including:
a plurality of glass particles;
a binder composition for fusing the glass particles when the heat insulting composite is exposed to a temperature higher than 100° C.

Preferably, the glass particles are formed by oxides selected from the group consisting of SiO₂, B₂O₃, P₂O₅, GeO₂, AS₂O₅, As₂O₃, Sb₂O₃, and their mixtures thereof, and more preferably SiO₂. Alternatively, the glass particles may be glass spheres.

Additionally, the glass particles may further include modifiers selected from the group consisting of K₂O, Na₂O, CaO, BaO, PbO, ZnO, V₂O₅, ZrO₂, Bi₂O₃, Al₂O₃, oxides of Ti, oxides of Th, and their mixtures thereof.

Preferably, the glass particles have an average diameter of 0.05 micron to 1.5 micron, more preferably 0.75 micron.

Optionally, the glass particles are in an amount of 50 to 95 weight percent, more preferably 80 weight percent, and the binder composition is in an amount of 50 to 5 weight percent, more preferably 20 weight percent.

The binder composition includes a major component selected from the group consisting of carbides, Gypsum powder, Blakite, nitrides, calcium carbonate, oxides, titanates, sulfides, zinc selenide, zinc telluride, inorganic siloxane compound and their mixtures thereof. Carbides may be selected from the group consisting of aluminum carbide, calcium carbide, chromium carbide, hafnium carbide, molybdenum carbide, niobium carbide, silicon carbide, tantalum carbide, titanium carbide, tungsten carbide, vanadium carbide, zirconium carbide, and their mixtures thereof. Nitrides may be selected from the group consisting of boron nitride, calcium nitride, chromium nitride, germanium nitride, magnesium nitride, aluminum nitride, zirconium nitride, and their mixtures thereof. Oxides may be selected from the group consisting of aluminum oxide, germanium(IV) oxide, indium(II or III) oxide, magnesium oxide, silicon dioxide, silicon monoxide, thallium(III) oxide, barium calcium oxide, tungsten oxide, barium oxide, barium strontium tungsten oxide, bismuth(III) oxide, bismuth strontium calcium copper oxide, cadmium oxide brown, cerium(IV) oxide, chromium(III) oxide, chromium(VI) oxide, cobalt(II) oxide, copper(I) oxide, copper(II) oxide, dysprosium oxide, europium oxide, gadolinium oxide, gold(III) oxide hydrate, hafnium(IV) oxide, holmium(III) oxide, iridium(IV) oxide or iridium(IV) oxide hydrate, lanthanum oxide, lead(IV) oxide, lead(II) oxide yellow, lutetium (III) oxide, manganese(II, III or IV) oxides, molybdenum(IV) oxide, nickel oxide, niobium(II) oxide, niobium(IV) oxide, niobium(V) oxide, osmium tetroxide, palladium(II) oxide or its hydrate, palladium(II) oxide hydrate, prasedymium(III) oxide, rhenium(IV) oxide or its hydrate, rhodium(III) oxide or its hydrate, samarium oxide, silver(I or II) oxides, strontium oxide, tantalum(V) oxide, terbium oxide, terbium(III) oxide, thulium(III) oxide, tin(II or IV) oxides, tungsten(VI) oxide, vanadium(III, IV, or V) oxides, ytterbium oxide, zinc oxide, zirconium(IV) oxide, antimony tin oxide, iron(III) oxide, yttrium(III) oxide, calcium oxide, and their mixtures thereof. Titanates may be selected from the group consisting of barium titanate(IV), trontium titanate, and their mixtures thereof. Sulfides may be selected from the group consisting of aluminum sulfide, antimony pentasulfide, antimony(III) sulfide, arsenic(II, III, or V) sulfides, gallium(III) sulfide, germanium(II) sulfide, indium(III) sulfide red, phosphorus pentasulfide, phosphorus trisulfide, selenium sulphide, barium sulfide, bismuth(III) sulfide, calcium sulfide, copper(I) sulfide, copper(II) sulfide, gold(I or III) sulfide, iron(II) sulfide, lead(II) sulfide, lithium sulfide, manganese(II) sulfide, mercury(II) sulfide red, palladium(II) sulfide, platinum(IV) sulfide, rhenium(VII) sulfide, silver sulfide, sodium sulfide, strontium sulfide, thallium(I) sulfide, tin(II) sulfide, titanium(IV) sulfide, tungsten(IV) sulfide, zinc sulfide, molybdenum(IV) sulfide, and their mixtures thereof.

Preferably, the inorganic siloxane compound is AlSi₂ kaolinate (Al₂(Si₂O₅)(OH)₄).

Optionally, the binder composition may further includes a minor component selected from the group consisting of carbides, metals, alloys, and their mixtures thereof. Carbides may be selected from the group consisting of tungsten carbide, silicon carbide, and their mixtures thereof. Oxides may be selected from the group consisting of aluminum oxide, beryllium oxide, magnesium oxide, zirconium oxide, mullite (Al₆Si₂O₁₃), and their mixtures thereof. Metals may be selected from the group consisting of tungsten, chromium, beryllium, nickel, iron, copper, titanium, aluminum, and their mixtures thereof. Alloys may be selected from the group consisting of low alloy steels, stainless steels, cast irons, brasses, bronzes, and their mixtures thereof.

Preferably, the major component is in an amount of 70% to 80% by weight of the binder composition, and the minor component is in an amount of 20% to 30% by weight of the binder composition.

Advantageously, the binder composition is hydrolyzed.

It is another aspect of this invention to provide a method of manufacturing a heat insulating composite including the steps of mixing glass particles with a binder composition, such that the glass particles are fused when the heat insulting composite is exposed to a temperature higher than 100° C.

### BRIEF DESCRIPTION OF THE DRAWINGS

Preferred embodiments of the present invention will now be explained by way of example and with reference to the accompanying drawings in which:

FIG. 1 shows the temperature distribution of the heat-insulating composite having a thickness of 22 mm, when the composite is subjected to a temperature of 800° C. on the left hand side for 60 to 80 minutes.

### DETAILED DESCRIPTION OF THE PREFERRED EMBODIMENT

This invention is now described by way of example with reference to the FIGURE in the following paragraphs.

Objects, features, and aspects of the present invention are disclosed in or are apparent from the following description. It is to be understood by one of ordinary skilled in the art that the present discussion is a description of exemplary embodiments only, and is not intended as limiting the broader aspects of the present invention, which broader aspects are embodied in the exemplary constructions.

The heat insulating composite includes a plurality of glass particles, preferably glass spheres. The term “glass” refers to all materials that can form glass, including oxides of Si (SiO₂), B (B₂O₃), P(P₂O₅), Ge (GeO₂), As (As₂O₅ or As₂O₃), Sb (Sb₂O₃), which may also include modifiers, for example oxides of K (K₂O), Na (Na₂O), Ca (CaO), Ba (BaO), Pb (PbO), Zn (ZnO), V (V₂O₅), Zr (ZrO₂), and Bi (Bi₂O₃). The species in brackets refers to the stable oxide forms of the corresponding elements. Oxides of Ti, Al, and Th may also be included in various concentrations. Among all, oxides of Si are particularly preferred due to low cost and high availability. The glass spheres may have an average diameter of 0.05 mm to 1.5 mm. An average diameter of 0.75 micron is particularly preferred due to cost and availability considerations. It was found that, however, glass chunks having non-spherical shapes, for example cubic or even irregular shapes, also work for this invention. However, glass spheres are found to perform better for this invention and therefore is the preferred choice.

The heat insulating composite of this invention also includes a binder composition for fusing the glass particles when the heat insulting composite is exposed to a temperature higher than 100° C. The binder composition may include a major component, which can be selected from any one of the following compounds, or their mixtures:

carbides including aluminum carbide (preferably in powder, −325 mesh); boron carbide (preferably in powder); calcium carbide; chromium carbide; hafnium carbide; molybdenum carbide; niobium carbide; silicon carbide (preferably in nanopowder); tantalum carbide; titanium carbide; tungsten carbide (preferably in powder); vanadium carbide (preferably in powder); zirconium carbide (preferably in powder);

Gypsum powder; and Blakite;

nitrides including boron nitride (preferably in powder); calcium nitride; chromium nitride; germanium nitride; magnesium nitride; aluminum nitride (preferably in nanopowder); zirconium nitride;

calcium carbonate in various forms, including low in alkalies form, powder, random crystals;

oxides including aluminum oxide in various forms, including calcined, powder, Corundum, fused, granular, mesoporous and pellets; germanium(IV) oxide; indium(II or III) oxide; magnesium oxide in various forms including nanopowder, fused, fused in pieces form, fused in chips form; silicon dioxide in various forms including fused in pieces form and fused in granules forms; silicon monoxide; thallium(III) oxide; barium calcium oxide; tungsten oxide; barium oxide; barium strontium tungsten oxide; bismuth(III) oxide (preferably in powder); bismuth strontium calcium copper oxide (preferably in powder); cadmium oxide brown (preferably in powder); cerium(IV) oxide in various forms including powder, fused in pieces form; chromium(III) oxide in various forms including powder, fused in pieces form; chromium(VI) oxide preferably in crystals; cobalt(II) oxide; copper(I) oxide (preferably in powder); copper(II) oxide (preferably in powder); dysprosium oxide; europium oxide (preferably in 99.9% 28, 922-1); gadolinium oxide; gold(III) oxide hydrate; hafnium(IV) oxide (preferably in powder); holmium(III) oxide (preferably in 99.9% 20, 844-2); iridium(IV) oxide or iridium(IV) oxide hydrate; lanthanum oxide; lead(IV) oxide; lead(II) oxide yellow (preferably in powder); lutetium (III) oxide; manganese(II, III or IV) oxides; molybdenum(IV) oxide; nickel oxide; niobium(II) oxide; niobium(IV) oxide; niobium(V) oxide in various forms including lumps and pore 22 Å, 99.5%; osmium tetroxide; palladium(II) oxide or its hydrate; palladium(II) oxide hydrate; prasedymium(III) oxide; rhenium(IV) oxide or its hydrate; rhodium(III) oxide or its hydrate; samarium oxide in various forms including powder and fused; silver(I or II) oxides; strontium oxide; tantalum(V) oxide (preferably in lumps); terbium oxide; terbium(III) oxide; thulium(III) oxide; tin(II or IV) oxides (preferably in nanopowder); tungsten(I) oxide (preferably in powder, more preferably in nanopowder); vanadium(III, IV, or V) oxides; ytterbium oxide; zinc oxide in various forms including powder, more preferably nanopowder, or hydrate; zirconium(IV) oxide in various forms including powder, more preferably nanopowder, and sulphated forms; antimony tin oxide (preferably in nanopowder); iron(III) oxide (preferably in nanopowder); yttrium(III) oxide (preferably in nanopowder); calcium oxide (preferably in anhydrous powder);

titanates including barium titanate(IV) or trontium titanate (preferably in nanopowder);

sulfides including aluminum sulfide (preferably in granular form); antimony pentasulfide; antimony(III) sulfide (preferably in powder); arsenic(II, III, or V) sulfides; gallium(III) sulfide; germanium(II) sulfide; indium(III) sulfide red; phosphorus pentasulfide; phosphorus trisulfide; selenium sulphide; barium sulfide; bismuth(III) sulfide; calcium sulfide; copper(I) sulfide (preferably in powder, more preferably anhydrous); copper(II) sulfide (preferably in powder); gold(I or III) sulfide; iron(II) sulfide; lead(II) sulfide; lithium sulfide; manganese(II) sulfide; mercury(II) sulfide red; palladium(II) sulfide; platinum(IV) sulfide; rhenium(VII) sulfide; silver sulfide; sodium sulfide; strontium sulfide; thallium(I) sulfide; tin(II) sulfide; titanium(IV) sulfide (preferably in powder or anhydrous form); tungsten(IV) sulfide (preferably in powder); zinc sulfide (preferably in pieces); molybdenum(IV) sulfide (preferably in powder);

zinc selenide (preferably having coating quality and/or in powder);

zinc telluride (preferably having coating quality); and

inorganic siloxane compound including AlSi₂ kaolinate (Al₂(Si₂O₅)(OH)₄).

Among all of the above compounds, AlSi₂ kaolinate (Al₂(Si₂O₅)(OH)₄) is particularly preferred. It is found that the heat-insulating composite formed with AlSi₂ kaolinate as the major component of the binder composition is less brittle and more homogenized, and is capable to withstand higher temperatures.

Other than the above major component of the binder composition, additional compounds including carbides including tungsten carbide (WC) and silicon carbide (SiC); oxides including aluminum oxide (Al₂O₃), beryllium oxide (BeO), magnesium oxide (MgO), zirconium oxide (ZrO), mullite (Al₆Si₂O₁₃); metals including tungsten (W), chromium (Cr), beryllium (Be), nickel (Ni), iron (Fe), copper (Cu), titanium (Ti) and aluminum (Al); and alloys including low alloy steels, stainless steels, cast irons, brasses and bronzes; and their mixtures thereof may also present in the binder composition as the minor component. The presence of this minor component may further enhance the functionality of the minor components, for example, the working temperatures and pressures of the resulting heat insulating composite may be enhanced. However, it should be note that the presence of this minor component may be optionally.

The glass particles and the binder composition may be in any desired amounts. Typically, the glass spheres may be in an amount of 50 to 95, more preferably 80, weight percent and the binder composition in an amount of 50 to 5, more preferably 20, weight percent.

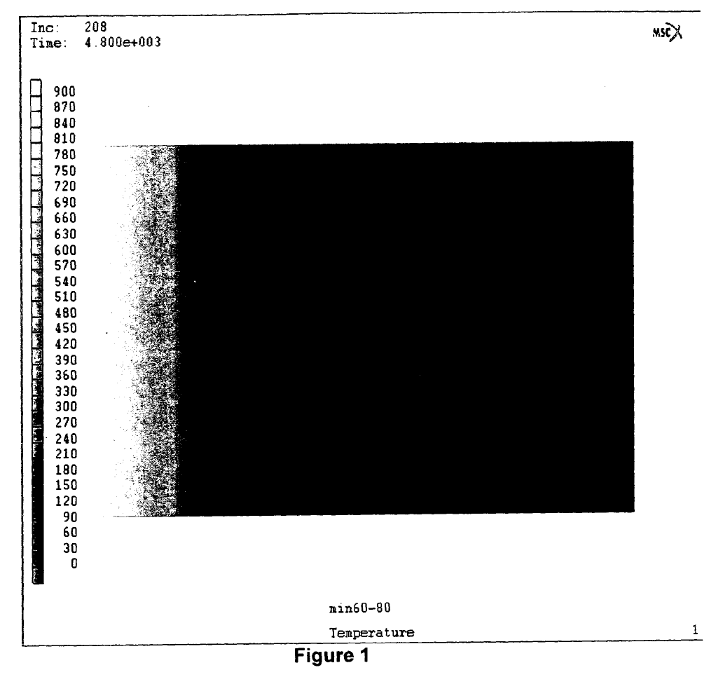

It was found that, surprisingly, when the heat-insulating composite of this invention is heated above a certain temperature, typically over 100° C., the binder composition and the glass particles “fused” to form an insulating ceramic-like structure. This reaction is found to be endothermic, and more importantly, the resulting ceramic composition is found to be highly insulating and not brittle. Typically, the composite of this invention may be formed as a layer on the outside of an object to be protected, and the heat will first attack the outer surface. It was found that as the heat progresses from the outer surface to the inner surface, plurality of laminated ceramic-like structures are formed, which may assist further in insulating the heat. Interestingly, these laminated ceramic-like structures are found to be rubber-like and therefore not brittle. FIG. 1 shows the temperature distribution of the heat-insulating composite having a thickness of 22 mm, when the composite is subjected to a temperature of 900° C. on the left hand side for 60 to 80 minutes. The sample had thermal sensors inserted at intervals of 4 mm and the temperature of the kiln was stabilized at 800° C. before the sample was introduced. Detail results are shown as follows:

### After 30 Minutes:

Surface temperature=815 degrees centigrade
2 mm=500 degrees centigrade
6 mm=250 degrees centigrade
10 mm=122 degrees centigrade
14 mm 66 degrees centigrade
18 mm 30 degrees centigrade
22 mm=22 degrees centigrade

### After 60 Minutes:

Surface temperature=825 degrees centigrade
2 mm=500 degrees centigrade
6 mm=250 degrees centigrade
10 mm=130 degrees centigrade
14 mm 75 degrees centigrade
18 mm 35 degrees centigrade
22 mm=25 degrees centigrade

It can be seen that a large portion of the composite of this invention is still kept at a temperature below 100° C. This demonstrates the effectiveness of the heat-insulating property of the composite of this invention.

What is even more advantageous is that the composite of this invention is found to be even better in heat-insulating if it is exposed to elevated temperatures once. The laminated ceramic-like structures formed during the first exposure to high temperatures are itself heat-insulating in the first place, which assists further in insulating the object to be protected from heat.

Tables below show the temperature distribution of the composite of this invention comparing to the binder or the glass spheres, which act as controls.

| | T | T | | T | T |
|---|---|---|---|---|---|
| Binder Alone | 30′ | 60′ | Composite Material | 30′ | 60′ |
| Thickness (mm) | (° C.) | (° C.) | Thickness (mm) | (° C.) | (° C.) |
| 0 | 820 | 820 | 0 | 815 | 825 |
| 2 | 750 | 750 | 2 | 500 | 500 |
| 6 | 450 | 550 | 6 | 250 | 250 |
| 10 | 275 | 350 | 10 | 122.6 | 130 |
| 14 | 220 | 300 | 14 | 66.8 | 75 |
| 18 | 180 | 260 | 18 | 30.3 | 35 |
| 22 | 140 | 200 | 22 | 22.1 | 25 |

| | | | Composite | | |
|---|---|---|---|---|---|
| Solid Glass | Time | T | with Bigger | Time | T |
| Spheres Alone | 30′ | 60′ | Glass Spheres | 30′ | 60′ |
| Thickness (mm) | (° C.) | (° C.) | Thickness (mm) | (° C.) | (° C.) |
| 0 | 820 | 820 | 0 | 815 | 820 |
| 2 | 750 | 765 | 2 | 600 | 625 |
| 6 | 420 | 550 | 6 | 300 | 350 |
| 10 | 260 | 340 | 10 | 150 | 220 |
| 14 | 199 | 250 | 14 | 140 | 190 |
| 18 | 140 | 200 | 18 | 100 | 150 |
| 22 | 120 | 180 | 22 | 50 | 70 |

The “Bigger Glass Spheres” used in the above tests refer to glass spheres having an average diameter of bigger than 0.75 mm.

The composite of this invention can be used in various occasions where high degree of heat insulation is required, for example, in building fire-resistant panels, or even space shuttle.

Other than the heat-insulating properties demonstrated above, one may realize that the composite of this invention may not evolve toxic gases when it is heated. Further, the composite of this invention may be manufactured relatively easily as non-toxic substances are involved. Additionally, the materials required are relatively cheap.

### EXAMPLES

### Example 1

### Composition

75 g SiC (400 mesh)

150 g Al Si₂ Kaolinite powder (Al₂Si₂O₅ (OH)₄)

H₂O approx 100 ml. (*the slurry should be of medium viscosity.)

675 g of glass beads (75-100 microns)

The resulting samples can be cured at room temperature however stronger ceramic bonds are formed at high temperatures. E.g. via arc-plasma flame surface treatment

Mixing Kaolinite Al₂ (Si₂O₅)(OH)₄ powder and silicon carbide=25% H₂O hydrolysed to make silyl silicon emulsion thixotropic polysiloxane ceramic slurry which act as the binder in the samples. Hydrosilylation occurs with the methyl silane surface primer on the solid glass beads particles which flocculate (clump) and settle quickly in the saline water. e.g. Me₃SiOH(OH₂)₄ the interaction of complex oxides and non oxide silicates silica and oligomeric methylsiloxane surfaces.

The solid glass beads surface cross links with the surfaces of the kaolinite Al₂(Si₂O₅)(OH)₄ powder and silicon carbide, forming silanol loops while the other part is redistributed to neighbouring surface homologues. The methylsiloxy surface groups formed at room temperature can undergo further reaction with the other methylsiloxanes surfaces above 250° C. or a plasma flame surface treatment of the insulating thixotropic ceramic composition to create a low porosity, a smooth surface, high micro hardness and fracture toughness.

### Example 2

### Composition

75 g SiC (400 mesh)

150 g Al Si₂ Kaolinite powder (Al₂Si₂O₅ (OH)₄)

Solid glass beads (0.75 mm in diameter).

The resulting samples can be cured via induction or vacuum thermal ovens where stronger ceramic bonds are formed at high temperatures also via arc-plasma flame surface treatment.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1-46. (canceled)

47. A heat insulating composite, including a plurality of glass particles and a binder composition for fusing the glass particles when the heat insulating composite is exposed to temperatures higher than 100° C., wherein the glass particles are in an amount of 50 to 95 weight percent and the binder composition is in an amount of 5 to 50 weight percent, the binder composition including a major component consisting essentially of kaolinate (Al₂(Si₂O₅)(OH)₄) and a minor component, wherein the major component is in an amount of 70 to 80 weight percent of the binder composition.

48. The heat insulating composite of claim 1, wherein the kaolinate component is 4 to 37.5 weight percent of the whole composite material.

49. The heat insulating composite of claim 1, wherein the glass particles are in an amount of 80 weight percent, and the binder composition is in an amount of 20 weight percent.

50. The heat insulating composite of claim 1, wherein the glass particles are in the form of glass chunks or glass spheres.

51. The heat insulating composite of claim 4, wherein the glass particles are in the form of glass spheres and have an average diameter of 0.05 micron to 1.5 micron.

52. The heat insulating composite of claim 5, wherein the glass particles have an average diameter of 0.75 micron.

53. The heat insulating composite of claim 1, wherein the glass particles are formed by oxides selected from the group consisting of SiO₂, B₂O₃, P₂O₅, GeO₂, As₂O₅, As₂O₃, Sb₂O₃, and mixtures thereof.

54. The heat insulating composite of claim 1, wherein the glass particles further include modifiers selected from the group consisting of K₂O, Na₂O, CaO, BaO, PbO, ZnO, V₂O₅, ZrO₂, Bi₂O₃, Al₂O₃, oxides of Ti, oxides of Th, and mixtures thereof.

55. The heat insulating composite of claim 1, wherein the binder composition further includes one or more components selected from the group consisting of carbides, gypsum powder, blakite, nitrides, calcium carbonate, oxides, titanates, sulfides, zinc selenide, zinc telluride, and mixtures thereof.

56. The heat insulating composite of claim 55, wherein the carbides are selected from the group consisting of aluminum carbide, calcium carbide, chromium carbide, hafnium carbide, molybdenum carbide, niobium carbide, silicon carbide, tantalum carbide, titanium carbide, tungsten carbide, vanadium carbide, zirconium carbide, and mixtures thereof.

57. The heat insulating composite of claim 55, wherein the nitrides are selected from the group consisting of boron nitride, calcium nitride, chromium nitride, germanium nitride, magnesium nitride, aluminum nitride, zirconium nitride, and mixtures thereof.

58. The heat insulating composition of claim 55, wherein the oxides are selected from the group consisting of aluminum oxide, germanium(IV) oxide, indium(III or III) oxide, magnesium oxide, silicon dioxide, silicon monoxide, thallium(III) oxide, barium calcium oxide, tungsten oxide, barium oxide, barium strontium tungsten oxide, bismuth(III) oxide, bismuth strontium calcium copper oxide, cadmium oxide brown, cerium(IV) oxide, chromium(III) oxide, chromium(VI) oxide, cobalt(II) oxide, copper(I) oxide, copper(II) oxide, dysprosium oxide, europium oxide, gadolinium oxide, gold(III) oxide hydrate, hafnium(IV) oxide, holmium(III) oxide, iridium(IV) oxide or iridium(IV) oxide hydrate, lanthanum oxide, lead(IV) oxide, lead(II) oxide yellow, lutetium (III) oxide, manganese(II, III or IV) oxides, molybdenum(IV) oxide, nickel oxide, niobium(II) oxide, niobium(IV) oxide, niobium(V) oxide, osmium tetroxide, palladium(II) oxide or its hydrate, palladium(II) oxide hydrate, prasedymium(III) oxide, rhenium(IV) oxide or its hydrate, rhodium(III) oxide or its hydrate, samarium oxide, silver(I or II) oxides, strontium oxide, tantalum(V) oxide, terbium oxide, terbium(III) oxide, thulium(III) oxide, tin(II or IV) oxides, tungsten(VI) oxide, vanadium(III, IV, or V) oxides, ytterbium oxide, zinc oxide, zirconium(IV) oxide, antimony tin oxide, iron(III) oxide, yttrium(III) oxide, calcium oxide, and mixtures thereof.

59. The heat insulating composite of claim 55, wherein the titanates are selected from the group consisting of barium titanate(IV), trontium titanate, and mixtures thereof.

60. The heat insulating composite of claim 55, wherein the sulfides are selected from the group consisting of aluminum sulfide, antimony pentasulfide, antimony(III) sulfide, arsenic(II, III, or V) sulfides, gallium(III) sulfide, germanium(II) sulfide, indium(III) sulfide red, phosphorus pentasulfide, phosphorus trisulfide, selenium sulphide, barium sulfide, bismuth(III) sulfide, calcium sulfide, copper(I) sulfide, copper(II) sulfide, gold(I or III) sulfide, iron(II) sulfide, lead(II) sulfide, lithium sulfide, manganese(II) sulfide, mercury(II) sulfide red, palladium(II) sulfide, platinum(rV) sulfide, rhenium(VII) sulfide, silver sulfide, sodium sulfide, strontium sulfide, thallium(I) sulfide, tin(II) sulfide, titanium(IV) sulfide, tungsten(IV) sulfide, zinc sulfide, molybdenum(IV) sulfide, and mixtures thereof.

61. The heat insulating composite of claim 55, wherein the binder composition further includes a minor component selected from the group consisting of carbides, metals, alloys, and mixtures thereof.

62. The heat insulating composite of claim 61, wherein the carbides are selecting from the group consisting of tungsten carbide, silicon carbide, and mixtures thereof.

63. The heat insulating composite of claim 61, wherein the oxides are selected from the group consisting of aluminum oxide, beryllium oxide, magnesium oxide, zirconium oxide, mullite (Al₆Si₂Oi₃), and mixtures thereof.

64. The heat insulating composite of claim 61, wherein the metals are selected from the group consisting of tungsten, chromium, beryllium, nickel, iron, copper, titanium, aluminum, and mixtures thereof.

65. The heat insulating composite of claim 61, wherein the alloys are selected from the group consisting of low alloy steels, stainless steels, cast irons, brasses, bronzes, and mixtures thereof.

66. The heat insulating composite of claim 61, wherein the major component is in an amount of 70% to 80% by weight of the binder composition, and the minor component is in an amount of 20% to 30% by weight of the binder composition.

67. A method of manufacturing a heat insulating composite, containing glass particles and a binder composition, according to claim 1, such that the glass particles are fused when the heat insulating composite is exposed to a temperature higher than 100° C.
